(19) United States
(12) Patent Application Publication
(10) Pub. No.: US 2025/0189632 A1
(43) Pub. Date: Jun. 12, 2025

(54) INFORMATION PROCESSING DEVICE, INFORMATION PROCESSING METHOD, AND PROGRAM

(71) Applicant: SONY GROUP CORPORATION, TOKYO (JP)

(72) Inventors: MASATOSHI YOKOKAWA, TOKYO (JP); YUTA SAKURAI, TOKYO (JP)

(21) Appl. No.: 18/845,061

(22) PCT Filed: Mar. 8, 2023
(86) PCT No.: PCT/JP2023/008917

§ 371 Date: Sep. 9, 2024

(30) Foreign Application Priority Data
Mar. 18, 2022 (JP) 2022-043953

(51) Int. Cl. G01S 7/48; G01S 17/08

(52) U.S. Cl. CPC G01S 7/4808; G01S 17/08

(57) ABSTRACT

A data amount is reduced. An information processing device (100) includes a peak detection unit (110), a reflected light peak determination unit (120), and an output unit (130). The peak detection unit (110) detects at least one peak of a detection frequency in a time-of-flight histogram representing a distribution of a time of flight of reflected light detected by a two-dimensional pixel array unit, the reflected light being emitted from a light source and reflected from an object, by a frequency and a class of the detection frequency. The reflected light peak determination unit (120) determines whether or not the peak includes a reflected light peak corresponding to the reflected light. The output unit (130) outputs the reflected light peak as distance measurement data on the basis of a determination that the peak includes one reflected light peak, and outputs a candidate region of the time-of-flight histogram including a candidate for the reflected light peak as distance measurement data on the basis of a determination that the peak includes the plurality of reflected light peaks or a determination that the peak does not include the reflected light peak.

### FIELD

The present disclosure relates to an information processing device, an information processing method, and a program.

### BACKGROUND

A distance measurement device based on a time of flight (ToF) method that irradiates an object with light, detects reflected light reflected by the object, and measures a distance to the object by measuring a time of flight of the light is used. In this distance measurement device, a light receiving unit that detects the reflected light generates a histogram in which a detection frequency of the time of flight is a frequency. Data of this histogram is transmitted to a processing unit in a subsequent stage, and the processing unit calculates the distance (see, for example, Patent Literature 1).

### CITATION LIST

### Patent Literature

Patent Literature 1: JP 2021-038941 A

### SUMMARY

### Technical Problem

However, in the above-described conventional technique, since the data of the histogram is transmitted, there is a problem that a transmission data amount increases. In particular, when a distance measurement range is wide, there is a problem that a data amount of the histogram increases and data transmission becomes difficult.

Therefore, the present disclosure proposes an information processing device, an information processing method, and a program that reduce distance measurement data and shorten a transmission time.

### Solution to Problem

An information processing device according to the present disclosure includes: a peak detection unit that detects a peak of a detection frequency in a time-of-flight histogram representing a distribution of a time of flight of reflected light detected by a two-dimensional pixel array unit, the reflected light being emitted from a light source and reflected from an object, by a frequency and a class of the detection frequency; a reflected light peak determination unit that determines whether or not the peak includes a reflected light peak corresponding to the reflected light; and an output unit that outputs the reflected light peak as distance measurement data on a basis of a determination that the peak includes the one reflected light peak, and outputs a candidate region of the time-of-flight histogram including a candidate for the reflected light peak as distance measurement data on a basis of a determination that the peak includes a plurality of the reflected light peaks or a determination that the peak does not include the reflected light peak.

An information processing method according to the present disclosure includes: detecting a peak of a detection frequency in a time-of-flight histogram representing a distribution of a time of flight of reflected light detected by a two-dimensional pixel array unit, the reflected light being emitted from a light source and reflected from an object, by a frequency and a class of the detection frequency; determining whether or not the peak includes a reflected light peak corresponding to the reflected light; and outputting the reflected light peak as distance measurement data on a basis of a determination that the peak includes the one reflected light peak, and outputting a candidate region of the time-of-flight histogram including a candidate for the reflected light peak as distance measurement data on a basis of a determination that the peak includes a plurality of the reflected light peaks or a determination that the peak does not include the reflected light peak.

A program according to the present disclosure includes: a peak detection procedure of detecting a peak of a detection frequency in a time-of-flight histogram representing a distribution of a time of flight of reflected light detected by a two-dimensional pixel array unit, the reflected light being emitted from a light source and reflected from an object, by a frequency and a class of the detection frequency; a reflected light peak determination procedure of determining whether or not the peak includes a reflected light peak corresponding to the reflected light; and an output procedure of outputting the reflected light peak as distance measurement data on a basis of a determination that the peak includes the one reflected light peak, and outputting a candidate region of the time-of-flight histogram including a candidate for the reflected light peak as distance measurement data on a basis of a determination that the peak includes a plurality of the reflected light peaks or a determination that the peak does not include the reflected light peak.

### BRIEF DESCRIPTION OF DRAWINGS

FIG. 1 is a diagram illustrating a configuration example of a distance measurement device according to embodiments of the present disclosure.

FIG. 2A is a diagram illustrating an example of a time-of-flight data group according to the embodiments of the present disclosure.

FIG. 2B is a diagram explaining time-of-flight data according to the embodiments of the present disclosure.

FIG. 3A is a diagram illustrating an example of a time-of-flight histogram according to the embodiments of the present disclosure.

FIG. 3B is a diagram explaining the time-of-flight data according to the embodiments of the present disclosure.

FIG. 4 is a diagram illustrating a configuration example of an information processing device according to a first embodiment of the present disclosure.

FIG. 5 is a diagram illustrating a configuration example of a peak detection unit according to the embodiments of the present disclosure.

FIG. 6A is a diagram illustrating an example of peak detection according to the embodiments of the present disclosure.

FIG. 6B is a diagram illustrating an example of peak detection according to the embodiments of the present disclosure.

FIG. 6C is a diagram illustrating an example of detection of a reflected light peak according to the embodiments of the present disclosure.

FIG. 7A is a diagram illustrating an example of distance measurement data according to the embodiments of the present disclosure.

FIG. 7B is a diagram illustrating an example of distance measurement data according to the embodiments of the present disclosure.

FIG. 7C is a diagram illustrating an example of distance measurement data according to the embodiments of the present disclosure.

FIG. 8 is a diagram illustrating an example of an information processing method according to the first embodiment of the present disclosure.

FIG. 9 is a diagram illustrating a configuration example of an information processing device according to a second embodiment of the present disclosure.

### DESCRIPTION OF EMBODIMENTS

Hereinafter, embodiments of the present disclosure will be described in detail with reference to the drawings. The description will be given in the following order. Note that, in each of the following embodiments, the same parts are denoted by the same reference numerals, and redundant description will be omitted.
1. First Embodiment
2. Second Embodiment

### 1. First Embodiment

### [Configuration of Distance Measurement Device]

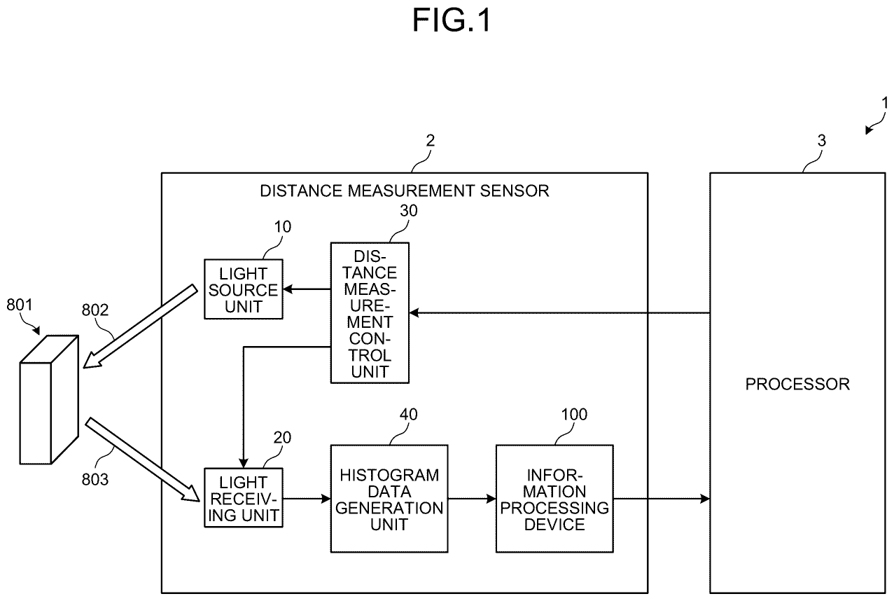

FIG. 1 is a diagram illustrating a configuration example of a distance measurement device according to embodiments of the present disclosure. The drawing is a block diagram illustrating a configuration example of a distance measurement device 1. The distance measurement device 1 is a device that measures a distance to an object. The distance measurement device 1 measures the distance to the object by emitting light to the object, detecting light reflected by the object, and measuring a time of flight which is a time from emission of the light to the object to incidence of the reflected light. The drawing illustrates a case where a distance to an object 801 is measured. In the drawing, the distance measurement device 1 irradiates the object 801 with emitted light 802 and detects reflected light 803.

The distance measurement device 1 includes a distance measurement sensor 2 and a processor 3. The distance measurement sensor 2 measures the above-described time of flight to generate distance data to the object. In addition, the distance measurement sensor 2 outputs the distance data to the processor 3.

The processor 3 controls the distance measurement sensor 2 and detects the distance to the object on the basis of the distance data output from the distance measurement sensor 2. The distance to the object can be calculated from the time of flight and speed of light. The processor 3 can be configured by a central processing unit (CPU) or a digital signal processor (DSP).

The distance measurement sensor 2 includes a light source unit 10, a light receiving unit 20, a distance measurement control unit 30, a histogram data generation unit 40, and an information processing device 100.

The light source unit 10 emits emitted light (emitted light 802) to an object. For example, a laser diode can be used for this light source unit 10.

The light receiving unit 20 detects reflected light (reflected light 803) from an object. This light receiving unit 20 includes a pixel array unit in which a plurality of light receiving pixels each having a light receiving element that detects reflected light is arranged in a two-dimensional matrix shape. For this light receiving element, a single photon avalanche diode (SPAD) can be used. In addition, the light receiving unit 20 generates an image signal on the basis of the detected reflected light and outputs the image signal to the histogram data generation unit 40.

The histogram data generation unit 40 generates a time-of-flight histogram on the basis of the image signal from the light receiving unit 20. This time-of-flight histogram is a histogram representing a distribution of the time of flight of the reflected light emitted from the light source and reflected from the object by a frequency and a class of a detection frequency. The time-of-flight histogram is formed by integrating the detection frequencies of the plurality of reflected lights accompanying the emission of the plurality of emitted lights. The light receiving unit 20 described above includes the light receiving pixels arranged in the two-dimensional matrix, and generates the image signal for each light receiving pixel. The histogram data generation unit 40 generates a histogram for each pixel region in a two-dimensional matrix corresponding to these light receiving pixels. The plurality of time-of-flight histograms for each pixel region in the two-dimensional matrix is referred to as a time-of-flight histogram group. The histogram data generation unit 40 generates the time-of-flight histogram group on the basis of the image signals from the light receiving unit 20, and outputs the time-of-flight histogram group to the information processing device 100.

The distance measurement control unit 30 controls the light source unit 10 and the light receiving unit 20 to perform distance measurement. The distance measurement control unit 30 causes the light source unit 10 to emit laser light and notifies the light receiving unit 20 of emission timing. The light receiving unit 20 measures a time of flight on the basis of this notification.

The information processing device 100 processes the time-of-flight histogram group output from the histogram data generation unit 40. The information processing device 100 performs preprocessing of distance measurement, extracts a region of a class corresponding to the reflected light from the object from the time-of-flight histogram group, and outputs the region to the processor 3.

The time-of-flight histogram included in the time-of-flight histogram group includes data based on light other than the reflected light from the object. By extracting a portion corresponding to the reflected light from the object from such a time-of-flight histogram and detecting the time of flight, it is possible to accurately measure the distance. Note that the light other than the reflected light corresponds to, for example, ambient light that is light based on sunlight or the like, or light obtained by irregularly reflecting light from the light source unit 10 by an object other than the object and entering the light receiving unit 20.

As the preprocessing described above, the information processing device 100 extracts the region of the reflected light from the object on the basis of reliability of the time of flight in the time-of-flight histogram. Specifically, the information processing device 100 detects the reliability on the basis of a shape of the histogram. The region with high reliability is output to the processor 3 as a region of the reflected light indicating the distance to the object. In this case, the processor 3 detects the distance to the object on the basis of the region.

Furthermore, in a case where the region of the reflected light indicating the distance to the object cannot be narrowed down, the information processing device 100 outputs a region (candidate region) of a histogram including a candidate for the region of the reflected light indicating the distance to the object to the processor 3. In this case, the processor 3 further performs signal processing such as noise removal on the data output from the information processing device 100, and detects the region of the reflected light indicating the distance.

### [Configuration of Time-of-Flight Data Group]

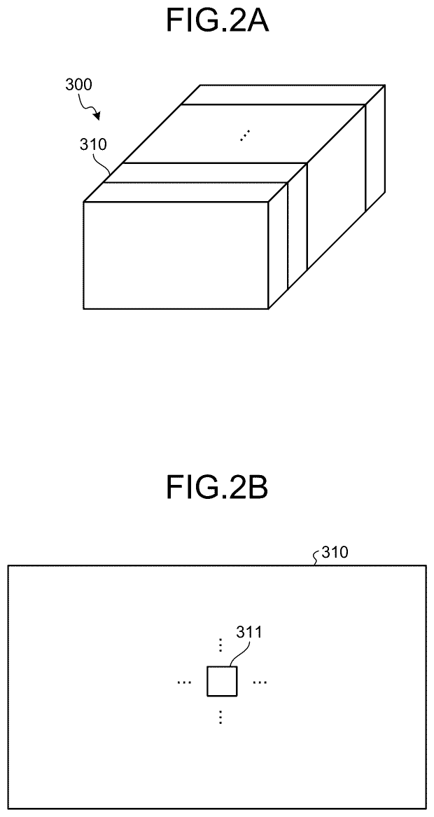

FIG. 2A is a diagram illustrating an example of a time-of-flight data group according to the embodiments of the present disclosure. A time-of-flight data group 300 in the drawing has a plurality of pieces of time-of-flight data 310. The time-of-flight data 310 included in the time-of-flight data group 300 is arranged in time series. In addition, a pixel (pixel region 311) of each time-of-flight data 310 stores a detection frequency of a corresponding class width (bin: bins) of a time-of-flight histogram. The time-of-flight data group 300 is three-dimensional data having a spread in X, Y, and Z directions representing depth.

FIG. 2B is a diagram illustrating the time-of-flight data according to the embodiments of the present disclosure. The time-of-flight data 310 stores data of the plurality of pixel regions. In the pixel region 311 in the drawing, a frequency of a class corresponding to the time-of-flight data 310 of the histogram of the pixel in the light receiving unit 20 corresponding to the pixel is stored. The frequency of the class corresponds to a detection frequency of the time of flight.

### [Configuration of Time-of-Flight Histogram]

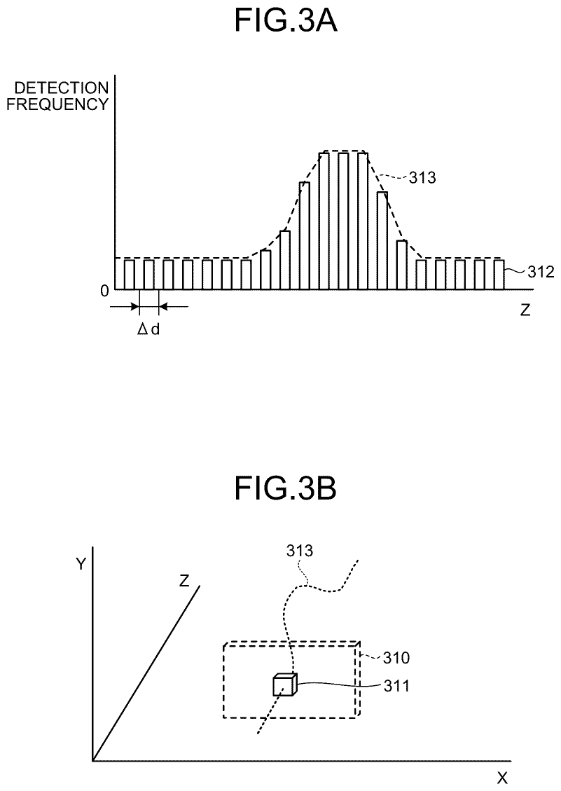

FIG. 3A is a diagram illustrating an example of a time-of-flight histogram according to the embodiments of the present disclosure. The drawing is a diagram illustrating an example of a histogram generated by the light receiving unit 20. The histogram in the drawing is a graph in which a frequency 312 of a detection frequency of a class width Δd is disposed over a detection range of a time of flight. The horizontal axis in the drawing represents the Z direction of the time-of-flight data group 300 illustrated in FIG. 2A. This Z direction corresponds to the time of flight. The drawing further indicates a time-of-flight histogram 313 represented by a curve. In the time-of-flight histogram 313 of the drawing, an upwardly protruding region is a region of a class in which reflected light or the like is detected. This protruding region is referred to as a peak.

FIG. 3B is a diagram illustrating the time-of-flight data according to the embodiments of the present disclosure. This drawing illustrates the time-of-flight data 310 extracted from the time-of-flight data group 300. A detection frequency of one class of the time-of-flight histogram 313 is stored in the pixel region 311 of the time-of-flight data 310. A plurality of such pixels is arranged in the X and Y directions. Further, time-of-flight data similar to the time-of-flight data 310 is arranged in time series in a depth direction to constitute the time-of-flight data group 300. For example, in a case where a distance measurement range is 150 m and resolution (class width) is 15 cm, there are 1000 pieces of data in a Z-axis direction. This data is generated for each pixel. This data is generated for each pixel region. The time-of-flight data group 300 can also be regarded as a set of time-of-flight histograms 313 for each two-dimensional pixel region. This set of time-of-flight histograms 313 corresponds to the time-of-flight histogram group described above. The histogram data generation unit 40 in FIG. 1 generates a time-of-flight histogram in a time-series frame period and sequentially outputs the time-of-flight histogram.

When the processor 3 processes such a time-of-flight histogram group, a processing load on the processor 3 increases. In addition, a transmission time of the time-of-flight histogram group between the distance measurement sensor 2 and the processor 3 becomes long. Therefore, the preprocessing is performed by the information processing device 100 described above.

### [Configuration of Information Processing Device]

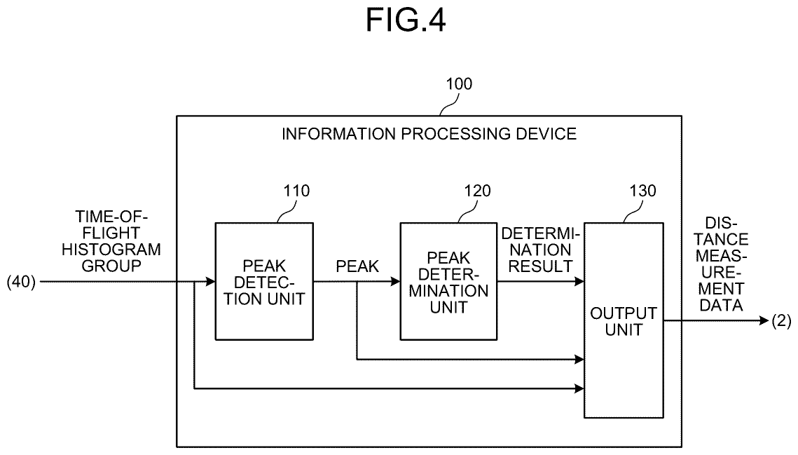

FIG. 4 is a diagram illustrating a configuration example of the information processing device according to a first embodiment of the present disclosure. The drawing is a block diagram illustrating a configuration example of the information processing device 100. The information processing device 100 includes a peak detection unit 110, a reflected light peak determination unit 120, and an output unit 130.

The peak detection unit 110 detects a peak from the time-of-flight histogram of the time-of-flight histogram group. This peak detection unit 110 detects a peak for each pixel region and outputs the peak to the reflected light peak determination unit 120 and the output unit 130.

The reflected light peak determination unit 120 determines whether the peak output from the peak detection unit 110 includes a reflected light peak corresponding to reflected light. The reflected light peak determination unit 120 outputs a determination result to the output unit 130. Details of detection of the reflected light peak will be described later.

The output unit 130 outputs distance measurement data on the basis of the determination result by the reflected light peak determination unit 120. This output unit 130 outputs a reflected light peak as distance measurement data on the basis of a determination that the peak includes one reflected light peak, and outputs a candidate region of a time-of-flight histogram including a candidate for the reflected light peak as distance measurement data on the basis of a determination that the peak includes a plurality of reflected light peaks or a determination that the peak does not include the reflected light peak. The distance measurement data from the output unit 130 is transmitted to the processor 3 as an output of the information processing device 100. In this manner, the output unit 130 selects data to be transmitted as distance measurement data according to a state of detection of the reflected light peak.

### [Configuration of Peak Detection Unit]

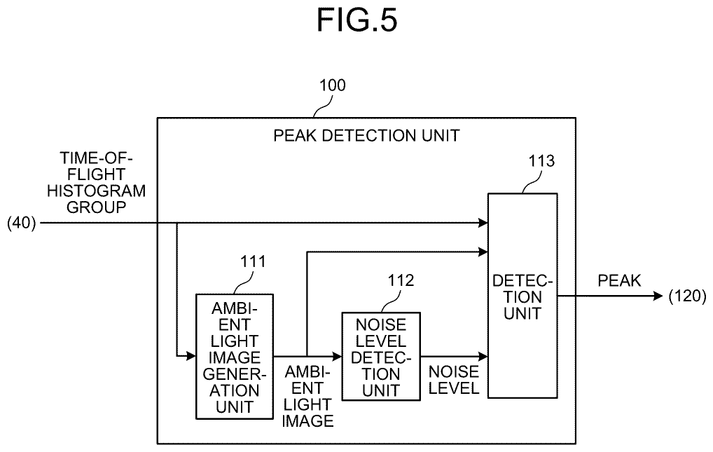

FIG. 5 is a diagram illustrating a configuration example of the peak detection unit according to the embodiments of the present disclosure. The drawing is a block diagram illustrating a configuration example of the peak detection unit 110. The peak detection unit 110 includes an ambient light image generation unit 111, a noise level detection unit 112, and a detection unit 113.

The ambient light image generation unit 111 generates an ambient light image. The ambient light image is an image based on a detection frequency of ambient light, and is an image based on the ambient light for each pixel region. A component of the detection frequency of the ambient light in the time-of-flight histogram is an error of time-of-flight detection. Therefore, by detecting the detection frequency of the ambient light and subtracting the detection frequency from the time-of-flight histogram, the error of the time-of-flight detection can be reduced. The ambient light image generation unit 111 generates an ambient light image as the detection frequency of the ambient light. This ambient light image can be generated by taking an average value of detection frequencies of classes for the respective pixel regions. The generated ambient light image is output to the noise level detection unit 112 and the detection unit 113.

The noise level detection unit 112 detects a noise level of the time-of-flight histogram. This noise level detection unit 112 detects a noise level on the basis of the ambient light image and outputs the noise level to the detection unit 113. The noise level of the time-of-flight histogram depends on the ambient light. Therefore, a relationship between intensity of the ambient light and the noise level is measured in advance, and a measurement result is held in the noise level detection unit 112. The noise level detection unit 112 can detect the noise level for each pixel region from the ambient light image on the basis of this measurement result.

The detection unit 113 detects a peak from the time-of-flight histogram on the basis of the detection frequency of the ambient light. The detection unit 113 in the drawing detects a peak on the basis of the ambient light image and the noise level. The detection unit 113 outputs the detected peak to the reflected light peak determination unit 120. Detection of the peak by the detection unit 113 will be described later.

### [Detection of Peak and Reflected Light Peak]

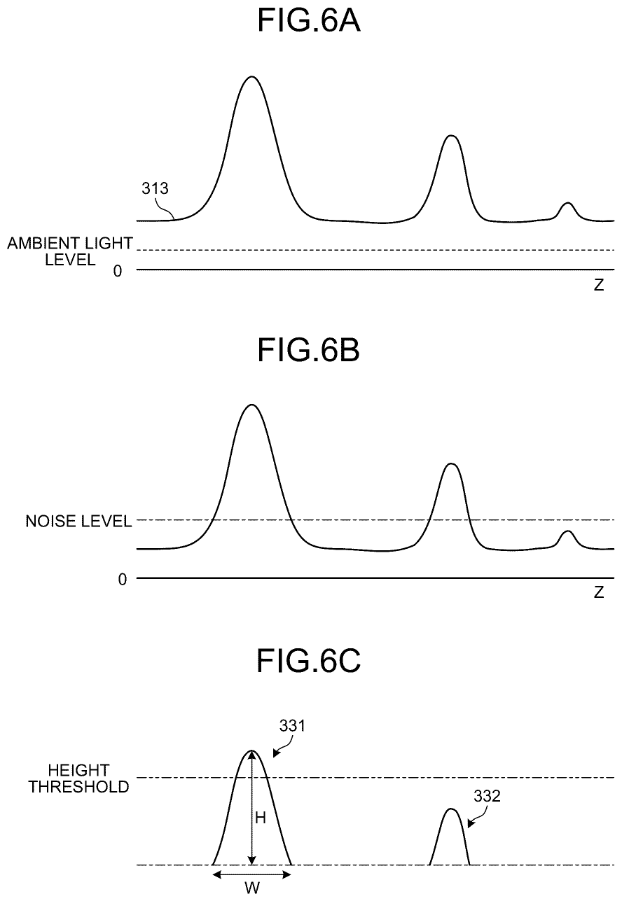

FIGS. 6A and 6B are diagrams each illustrating an example of peak detection according to the embodiments of the present disclosure. The drawings are diagrams each illustrating an example of detection of a peak in the detection unit 113 of the peak detection unit 110. Detection of the peak will be described by taking the time-of-flight histogram 313 in the drawings as an example. The horizontal axis in the drawings represents the Z axis.

FIG. 6A is a diagram illustrating a relationship between the time-of-flight histogram 313 and an ambient light frequency based on the ambient light image. By subtracting the ambient light frequency from the time-of-flight histogram 313, an influence of the ambient light can be removed.

FIG. 6B is a diagram illustrating a relationship between a time-of-flight histogram 314 obtained by subtracting the ambient light frequency from the time-of-flight histogram 313 and the noise level. The detection unit 113 detects a region exceeding the noise level in the time-of-flight histogram 314 as a peak. In the drawing, regions 331 and 332 are peaks. The detection unit 113 extracts and outputs regions of classes of the regions 331 and 332 as peaks.

FIG. 6C is a diagram illustrating an example of determination of a reflected light peak according to the embodiments of the present disclosure. The drawing is a diagram illustrating an example of determination of a reflected light peak in the reflected light peak determination unit 120. The reflected light peak determination unit 120 includes a counter that counts a class width, and detects a width of the input peak. In addition, the reflected light peak determination unit 120 detects a maximum value of a detection frequency of the input peak.

Next, the reflected light peak determination unit 120 determines the reflected light peak on the basis of thresholds of the detection frequency and the width of the peak. In the region 331 in the drawing, “H” and “W” represent a maximum detection frequency (height) and a width of the peak, respectively. When both “H” and “W” exceed the thresholds, the peak is determined as the reflected light peak. This is because such a peak (region 331) has a high possibility of a class corresponding to the reflected light and high reliability.

On the other hand, the reflected light peak determination unit 120 recognizes reliability of a peak having a shape exceeding any one of the thresholds of the detection frequency and the width as medium reliability, and recognizes a peak having a shape falling below both the thresholds of the detection frequency and the width as low reliability. A two-dot chain line in the drawing represents the threshold of the detection frequency. The reflected light peak determination unit 120 determines that a peak (region 332) having a maximum detection frequency smaller than the threshold of the detection frequency does not correspond to the reflected light peak and deletes the peak.

### [Distance Measurement Data]

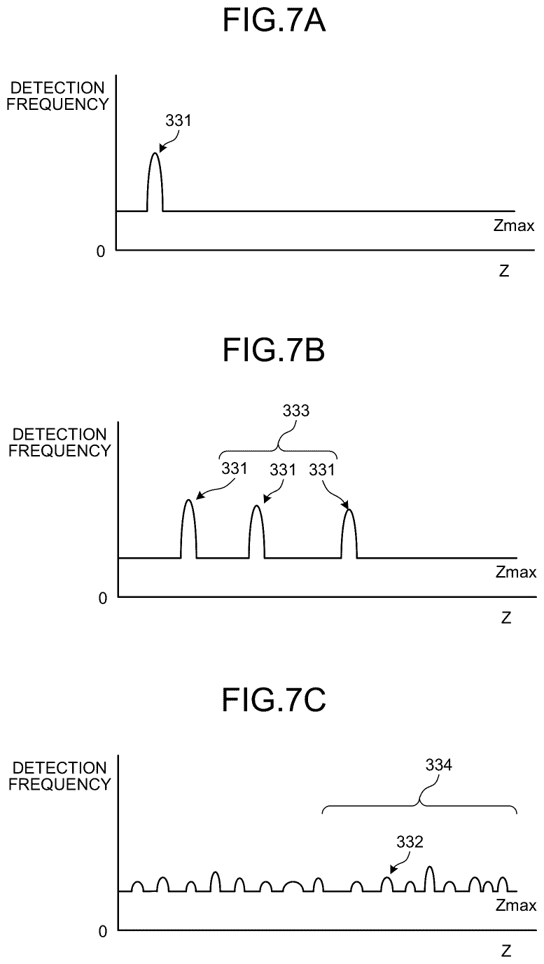

FIGS. 7A, 7B, and 7C are diagrams each illustrating an example of distance measurement data according to the embodiments of the present disclosure. The drawings are diagrams each illustrating an example of distance measurement data output to the processor 3 by the output unit 130. The drawings illustrate a simplified time-of-flight histogram, and the horizontal axis of the drawings represents the Z axis. Note that “Zmax” of the time-of-flight histogram in the drawings represents an end (farthest part) of the time-of-flight histogram.

FIG. 7A illustrates an example of a case where the reflected light peak determination unit 120 determines that the peak from the peak detection unit 161 includes one reflected light peak (region 331). In this case, the output unit 130 determines that the region is distance measurement data representing the time of flight to the object, and outputs only data of a class of the region 331. This is because there is a high possibility that it is a peak in which reflected light of an optical path that is not interfered with an object other than the object 801, such as the emitted light 802 and the reflected light 803 in FIG. 1, has been detected. For example, the reflected light peak determination unit 120 outputs data of a class in a predetermined range including a class of a peak in the region 331 and transmits the data to the processor 3. For example, a value “60” can be applied to this predetermined range. Note that the output unit 130 can also output a maximum detection frequency of the region 331.

FIG. 7B illustrates an example of a case where the reflected light peak determination unit 120 determines that the peak from the peak detection unit 161 includes a plurality of reflected light peaks (regions 331). In this case, the output unit 130 outputs a region 333, which is the plurality of regions 331, as distance measurement data including a reflected light peak candidate. In such a case, for example, there is a high possibility that the head region 331 is a peak based on reflected light and the subsequent regions 331 are ghosts caused by a multipath or the like. The reflected light peak determination unit 120 outputs the plurality of regions 331 as candidate regions, and leaves the determination as to which of these is the peak based on the reflected light to the processor 3 in a subsequent stage. The output unit 130 collectively outputs the candidate regions of classes (for example, 60 classes) in a predetermined range for each of these regions 331 as distance measurement data. Note that the output unit 130 can extract and output a predetermined number of reflected light peaks from the head among the plurality of reflected light peaks. For example, a value “5” can be applied to the predetermined number.

FIG. 7C illustrates an example of a case where the reflected light peak determination unit 120 determines that the peak from the peak detection unit 161 does not include a reflected light peak. In this case, the output unit 130 sets a region 334 of a class in a subsequent stage of the time-of-flight histogram as a candidate region, and outputs this candidate region as distance measurement data. In such a case, the peak based on the reflected light is highly likely to be buried in noise or the like. Therefore, a class in a wide range of the time-of-flight histogram is output as distance measurement data, and is left to signal processing such as noise removal by the processor 3 in the subsequent stage.

Note that, since a preceding stage portion of the time-of-flight histogram is a region where intensity of the reflected light is relatively high, a signal-to-noise ratio (S/N) is relatively high. Therefore, it is considered that a signal of the reflected light is not buried in the noise in the preceding stage portion. On the other hand, in the subsequent stage of the time-of-flight histogram, the intensity of the reflected light is low, and the signal of the reflected light is highly likely to be buried in the noise. That is, in such a time-of-flight histogram, since there is a high possibility that a component of the reflected light from the object is included in the subsequent stage, the class of the time-of-flight histogram in the subsequent stage is output.

In this manner, the output unit 130 selects and outputs the distance measurement data according to the determination result of the reflected light peak in the reflected light peak determination unit 120. This corresponds to selection of a transmission method (transmission mode) of the distance measurement data. In a case where the reliability is high as in a case where it is determined that one reflected light peak is included, the output unit 130 selects and outputs only the reflected light peak. Further, in a case where it is determined that the plurality of reflected light peaks is included, the output unit 130 selects and outputs only the classes of the plurality of reflected light peaks. Furthermore, in a case where it is determined that the reflected light peak is not included, the output unit 130 widely detects and outputs a region of the time-of-flight histogram having a high possibility of including a region of a class based on the reflected light. As a result, a transmission data amount can be reduced as compared with a case of transmitting data of all the time-of-flight histograms.

Furthermore, when outputting the distance measurement data, the output unit 130 can further output information on the transmission method. By outputting the information on the transmission method to the processor 3, it is possible to notify the processor 3 of size of the output distance measurement data. As a result, a data transmission time can be optimized.

### [Information Processing Method]

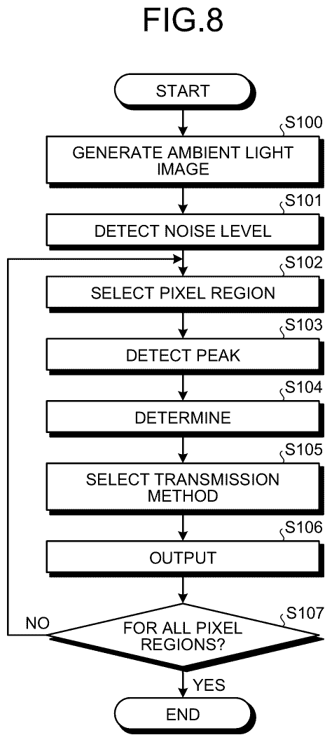

FIG. 8 is a diagram illustrating an example of an information processing method according to the first embodiment of the present disclosure. The drawing is a flowchart illustrating an example of an information processing method in the information processing device 100. First, the ambient light image generation unit 111 generates an ambient light image from a time-of-flight histogram group (step S100). Next, the noise level detection unit 112 detects a noise level from the ambient light image (step S101). Next, the information processing device 100 selects a pixel region of the time-of-flight histogram group (step S102). Next, the peak detection unit 110 detects a peak of the time-of-flight histogram in the selected pixel region (step S103). Next, the reflected light peak determination unit 120 determines whether or not a reflected light peak is included in the peak (step S104). Next, the output unit 130 selects a transmission method (step S105) and outputs distance measurement data (step S106).

Next, the information processing device 100 determines whether the output of the distance measurement data has been completed for all the pixel regions (step S107). In a case where the output of the distance measurement data has not been completed for all the pixel regions (step S107, No), the information processing device 100 proceeds to step S102 and selects another pixel region. On the other hand, in a case where the output of the distance measurement data has been completed for all the pixel regions (step S107, Yes), the information processing device 100 ends the processing.

Note that step S103 is an example of a peak detection procedure. Step S104 is an example of a peak determination procedure. Step S106 is an example of an output procedure.

As described above, the information processing device 100 according to the first embodiment of the present disclosure detects the reflected light peak in the time-of-flight histogram, and selects and transmits a format of the distance measurement data according to a detection result. As a result, a data amount of the distance measurement data can be reduced.

### 2. Second Embodiment

The information processing device 100 according to the first embodiment described above outputs distance measurement data. On the other hand, the information processing device 100 according to a second embodiment of the present disclosure is different from the above-described first embodiment in that distance measurement data is compressed.

### [Configuration of Imaging Device]

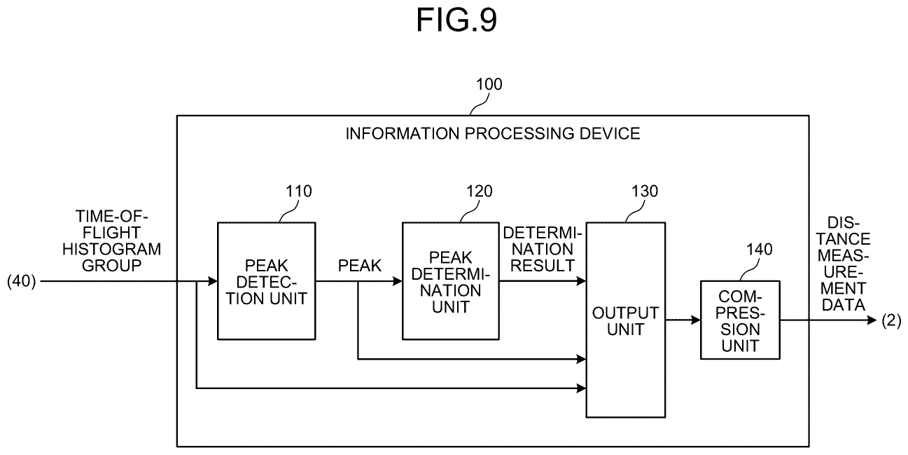

FIG. 9 is a diagram illustrating a configuration example of the information processing device according to the second embodiment of the present disclosure. Similarly to FIG. 4, the drawing is a block diagram illustrating a configuration example of the information processing device 100. The information processing device 100 in the drawing is different from the information processing device 100 in FIG. 4 in that a compression unit 140 is further included.

The compression unit 140 compresses distance measurement data from the output unit 130. The compression of the distance measurement data can be performed, for example, by extracting a change in an offset value of a predetermined detection frequency and generating a relative value. Alternatively, the compression can be performed by downsampling a time-of-flight histogram. The compression unit 140 outputs the compressed distance measurement data to the processor 3.

A configuration of the distance measurement device 1 other than this is similar to the configuration of the distance measurement device 1 according to the first embodiment of the present disclosure, and thus the description thereof will be omitted.

As described above, the information processing device 100 according to the second embodiment of the present disclosure can further reduce a data amount of the distance measurement data by compressing and transmitting the distance measurement data.

Note that the effects described in the present specification are merely examples and are not limited, and other effects may be provided.

Note that the present technology can also have the following configurations.

(1) An information processing device comprising:
a peak detection unit that detects a peak of a detection frequency in a time-of-flight histogram representing a distribution of a time of flight of reflected light detected by a two-dimensional pixel array unit, the reflected light being emitted from a light source and reflected from an object, by a frequency and a class of the detection frequency;
a reflected light peak determination unit that determines whether or not the peak includes a reflected light peak corresponding to the reflected light; and
an output unit that outputs the reflected light peak as distance measurement data on a basis of a determination that the peak includes the one reflected light peak, and outputs a candidate region of the time-of-flight histogram including a candidate for the reflected light peak as distance measurement data on a basis of a determination that the peak includes a plurality of the reflected light peaks or a determination that the peak does not include the reflected light peak.
   (2) The information processing device according to the above (1), wherein the reflected light peak determination unit detects the reflected light peak on a basis of a maximum detection frequency at the peak and a width of the peak.
   (3) The information processing device according to the above (1) or (2), wherein the output unit outputs a predetermined number of reflected light peaks among the plurality of detected reflected light peaks as a candidate region of the time-of-flight histogram including the candidate for the reflected light peak.
   (4) The information processing device according to the above (1) or (2), wherein the output unit outputs a region included in a predetermined range from an end of the time-of-flight histogram as a candidate region of the time-of-flight histogram including the candidate for the reflected light peak.
   (5) The information processing device according to any one of the above (1) to (4), further comprising
an ambient light detection unit that detects an ambient light frequency that is a detection frequency of ambient light on a basis of the time-of-flight histogram, wherein
the reflected light peak determination unit detects the peak on a basis of the time-of-flight histogram and the ambient light frequency.
   (6) The information processing device according to any one of the above (1) to (5), further comprising a data compression unit that compresses the distance measurement data.
   (7) An information processing method comprising:
detecting a peak of a detection frequency in a time-of-flight histogram representing a distribution of a time of flight of reflected light detected by a two-dimensional pixel array unit, the reflected light being emitted from a light source and reflected from an object, by a frequency and a class of the detection frequency;
determining whether or not the peak includes a reflected light peak corresponding to the reflected light; and
outputting the reflected light peak as distance measurement data on a basis of a determination that the peak includes the one reflected light peak, and outputting a candidate region of the time-of-flight histogram including a candidate for the reflected light peak as distance measurement data on a basis of a determination that the peak includes a plurality of the reflected light peaks or a determination that the peak does not include the reflected light peak.
   (8) A program comprising:
a peak detection procedure of detecting a peak of a detection frequency in a time-of-flight histogram representing a distribution of a time of flight of reflected light detected by a two-dimensional pixel array unit, the reflected light being emitted from a light source and reflected from an object, by a frequency and a class of the detection frequency;
a reflected light peak determination procedure of determining whether or not the peak includes a reflected light peak corresponding to the reflected light; and
an output procedure of outputting the reflected light peak as distance measurement data on a basis of a determination that the peak includes the one reflected light peak, and outputting a candidate region of the time-of-flight histogram including a candidate for the reflected light peak as distance measurement data on a basis of a determination that the peak includes a plurality of the reflected light peaks or a determination that the peak does not include the reflected light peak.

### REFERENCE SIGNS LIST

1 DISTANCE MEASUREMENT DEVICE
2 DISTANCE MEASUREMENT SENSOR
3 PROCESSOR
10 LIGHT SOURCE UNIT
20 LIGHT RECEIVING UNIT
40 HISTOGRAM DATA GENERATION UNIT
100 INFORMATION PROCESSING DEVICE
110 PEAK DETECTION UNIT
111 AMBIENT LIGHT IMAGE GENERATION UNIT
112 NOISE LEVEL DETECTION UNIT
113 DETECTION UNIT
120 REFLECTED LIGHT PEAK DETERMINATION UNIT
130 OUTPUT UNIT
140 COMPRESSION UNIT

1. An information processing device comprising:
a peak detection unit that detects a peak of a detection frequency in a time-of-flight histogram representing a distribution of a time of flight of reflected light detected by a two-dimensional pixel array unit, the reflected light being emitted from a light source and reflected from an object, by a frequency and a class of the detection frequency;
a reflected light peak determination unit that determines whether or not the peak includes a reflected light peak corresponding to the reflected light; and
an output unit that outputs the reflected light peak as distance measurement data on a basis of a determination that the peak includes the one reflected light peak, and outputs a candidate region of the time-of-flight histogram including a candidate for the reflected light peak as distance measurement data on a basis of a determination that the peak includes a plurality of the reflected light peaks or a determination that the peak does not include the reflected light peak.

2. The information processing device according to claim 1, wherein the reflected light peak determination unit detects the reflected light peak on a basis of a maximum detection frequency at the peak and a width of the peak.

3. The information processing device according to claim 1, wherein the output unit outputs a predetermined number of reflected light peaks among the plurality of detected reflected light peaks as a candidate region of the time-of-flight histogram including the candidate for the reflected light peak.

4. The information processing device according to claim 1, wherein the output unit outputs a region included in a predetermined range from an end of the time-of-flight histogram as a candidate region of the time-of-flight histogram including the candidate for the reflected light peak.

5. The information processing device according to claim 1, further comprising
an ambient light detection unit that detects an ambient light frequency that is a detection frequency of ambient light on a basis of the time-of-flight histogram, wherein
the reflected light peak determination unit detects the peak on a basis of the time-of-flight histogram and the ambient light frequency.

6. The information processing device according to claim 1, further comprising a data compression unit that compresses the distance measurement data.

7. An information processing method comprising:
detecting a peak of a detection frequency in a time-of-flight histogram representing a distribution of a time of flight of reflected light detected by a two-dimensional pixel array unit, the reflected light being emitted from a light source and reflected from an object, by a frequency and a class of the detection frequency;
determining whether or not the peak includes a reflected light peak corresponding to the reflected light; and
outputting the reflected light peak as distance measurement data on a basis of a determination that the peak includes the one reflected light peak, and outputting a candidate region of the time-of-flight histogram including a candidate for the reflected light peak as distance measurement data on a basis of a determination that the peak includes a plurality of the reflected light peaks or a determination that the peak does not include the reflected light peak.

8. A program comprising:
a peak detection procedure of detecting a peak of a detection frequency in a time-of-flight histogram representing a distribution of a time of flight of reflected light detected by a two-dimensional pixel array unit, the reflected light being emitted from a light source and reflected from an object, by a frequency and a class of the detection frequency;
a reflected light peak determination procedure of determining whether or not the peak includes a reflected light peak corresponding to the reflected light; and
an output procedure of outputting the reflected light peak as distance measurement data on a basis of a determination that the peak includes the one reflected light peak, and outputting a candidate region of the time-of-flight histogram including a candidate for the reflected light peak as distance measurement data on a basis of a determination that the peak includes a plurality of the reflected light peaks or a determination that the peak does not include the reflected light peak.
